(19) United States
(12) Patent Application Publication
(10) Pub. No.: US 2026/0100560 A1
(43) Pub. Date: Apr. 9, 2026

(54) CONNECTION STRUCTURE AND ELECTRICAL JUNCTION BOX

(71) Applicant: Yazaki Corporation, Tokyo (JP)

(72) Inventors: Mitsuaki MORIMOTO, Susono-shi (JP); Masami IDE, Susono-shi (JP)

(73) Assignee: Yazaki Corporation, Tokyo (JP)

(21) Appl. No.: 19/347,002

(22) Filed: Oct. 1, 2025

(30) Foreign Application Priority Data
Oct. 4, 2024 (JP) 2024-174926

(51) Int. Cl. H02G 3/08; B60R 16/03

(52) U.S. Cl. CPC H02G 3/08; B60R 16/03

(57) ABSTRACT

A connection structure of a plurality relays and busbars, wherein the relays include: a first relay for switching a first circuit as a predetermined electrical circuit between a powered and a non-powered states; and a second relay for switching a second circuit, which is different from the first circuit, as a predetermined electrical circuit between a powered and a non-powered states, the first and second circuits being configured to be supplied with power in the powered state and to be supplied with no power in the non-powered state. The busbars include: a first busbar connected to the first relay to form the first circuit; and a second busbar connected to the second relay to form the second circuit. The first busbar and the second busbar are connected for releasing heat, wherein the second busbar is in the non-powered state in the powered state of the first circuit.

### CROSS-REFERENCE TO RELATED APPLICATION(S)

The present application claims priority to Japanese Patent Application No. 2024-174926 filed on Oct. 4, 2024 in Japan which is incorporated in its entirety in the present application by reference.

### TECHNICAL FIELD

The present application relates to a connection structure and an electrical junction box.

### BACKGROUND ART

Conventionally, an electrical junction box is known which includes a plurality of electrical circuits (see e.g. Patent Document 1). As shown in FIG. 2 of Patent Document 1, an electronic unit box (electrical junction box) according to Patent Document 1 includes an accommodating case 3, an accommodating case 4, a plurality of relays 7 arranged in the accommodating case 3 and the accommodating case 4, and a busbar 9 connecting the relays 7 to each other. The electronic unit box further includes a heat releasing plate 6 which is integrally coupled with the busbar 9 via a thermally conductive sheet 10. The heat releasing plate 6 diffuses heat to the outside, which has been generated in the relays 7 and/or busbar 9 during supplying the electronic unit box with power.

### CITATION LIST

### Patent Literature

Patent Document 1: JP 2002-176279 A

### SUMMARY OF THE INVENTION

As shown in FIG. 4 of the above-mentioned Patent Document 1, the electronic unit box according to Patent Document 1 is configured such that a plurality of relay terminal holes 17 is formed in a single busbar 9, wherein the plurality of relays 7 is connected together via the relay terminal holes 17. In such a connecting structure, even in case of one relay 7 being switched off, heat is generated by other relays 7 which are switched on, whereby the heat is always transferred to the busbar 9 and the relays 7 and the busbar 9 are always subject to heat. This heat generation will be remarkable particularly when the electronic unit box is used in a high-power circuit. In order to increase a heat releasing effect of the relays 7 and/or busbar 9, it would be conceivable to increase a size of the heat releasing plate 6 and/or a mass of the busbar 9, for example. However, these measures are not easy due to constraints e.g. on internal layouts within the accommodating case 3 and the accommodating case 4.

An objective of the present invention is to obtain a connecting structure and an electrical junction box which enable heat generated in busbars and/or relays to be efficiently diffused, wherein the busbars and relays form electrical circuits.

In order to achieve the above-mentioned objective, a connection structure of relays and busbars forming a plurality of electrical circuits is provided, wherein the relays include: a first relay configured to switch a first circuit as a predetermined electrical circuit between a powered state and a non-powered state; the first circuit being configured to be supplied with power in the powered state and to be supplied with no power in the non-powered state; and a second relay configured to switch a second circuit as a predetermined electrical circuit between a powered state and a non-powered state, the second circuit being configured to be supplied with power in the powered state and to be supplied with no power in the non-powered state, wherein the second circuit is different from the first circuit, wherein the busbars include: a first busbar connected to the first relay to form the first circuit; and a second busbar connected to the second relay to form the second circuit, wherein the first busbar and the second busbar are connected to be capable of releasing heat, and wherein the second busbar is configured to be in the non-powered state in the powered state of the first circuit.

Furthermore, an electrical junction box includes: the aforementioned connection structure; and a case accommodating the connection structure.

With the present invention, a connection structure and an electrical junction box can be obtained which enable heat generated in busbars and/or relays to be efficiently diffused, wherein the busbars and relays form electrical circuits.

### BRIEF DESCRIPTION OF THE DRAWINGS

FIG. 1 shows a partial perspective view of an electrical junction box including a connection structure according to an embodiment;

FIG. 2 shows a partial sectional view of the electrical junction box along the line A-A as viewed in the direction of arrow in FIG. 1;

FIG. 3 shows a partial perspective view of an electrical junction box including a connection structure according to an exemplar variant; and

FIG. 4 shows a partial sectional view of the electrical junction box along the line B-B as viewed in the direction of arrow in FIG. 3.

### DETAILED DESCRIPTION OF THE PREFERRED EMBODIMENTS

Hereinafter, a connection structure 1 and an electrical junction box 100 including the connection structure 1 will be described. It is to be noted that in the figures, reference signs X, Y and Z indicate directions which extend orthogonally to each other. A direction indicated with reference sign X is defined as a “forward-rearward direction X”, wherein one direction and an opposite direction along the forward-rearward direction X are defined as a “forward direction X1” and “rearward direction X2”, respectively. A direction indicated with reference sign Y is defined as a “width direction Y”, wherein one direction and an opposite direction along the width direction Y are defined as a “right direction Y1” and “left direction Y2”, respectively. A direction indicated with reference sign Z is defined as a “upward-downward direction Z”, wherein one direction and an opposite direction along the upward-downward direction Z are defined as a “upward direction Z1” and “downward direction Z2”, respectively. It is to be noted that the above definitions of the directions are not provided for limiting the directions during producing and/or utilizing the connection structure 1 and electrical junction box 100, but merely for facilitating the understanding. It is further to be noted that in order to avoid complexity in the figures, some of the reference signs may be omitted in the figures in case where a plurality of features with similar functions are provided, for example for features of a second busbar 60 as described below.

The electrical junction box 100 is installed e.g. in a vehicle such as a hybrid vehicle, an electric vehicle, or fuel cell vehicle, wherein the electrical junction box 100 defines a plurality of electrical circuits, for example between a battery and an inverter. The electrical junction box 100 includes a case (not shown) which accommodates the connection structure 1 therein. The connection structure 1 is configured such that a plurality of conductors and a plurality of electronic components are connected to each other which form electrical circuits. The connection structure 1 includes a first relay 10, second relays 40 and fuses 50 as the plurality of electronic components. The connection structure 1 further includes busbars as the conductors for connecting the electronic components, wherein the busbars include first busbars 20, second busbars 60, third busbars 70 and fourth busbars 80.

It should be noted that two second relays 40 as well as two second busbars 60, two third busbars 70, two fourth busbars 80 and two fuses 50 which are directly or indirectly connected to the respective second relays 40. These second relays 40, second busbars 60, third busbars 70, fourth busbars 80 and fuses 50 are symmetrical on the right and left sides with respect to an imaginary line L, wherein the imaginary line L extends along the forward-rearward direction X through the middle of the first relay 10 in the width direction Y. Furthermore, the second relays 40, second busbars 60, third busbars 70, fourth busbars 80 and fuses 50 have substantially same structures. In the following description, a structure with the second relay 40, second busbar 60, third busbar 70, fourth busbar 80 and fuse 50 arranged on the left side Y2 with respect to the imaginary line L will be therefore described in more details. In addition, further detailed description of the structure arranged on the right side Y1 with respect to the imaginary line L will be omitted or simplified.

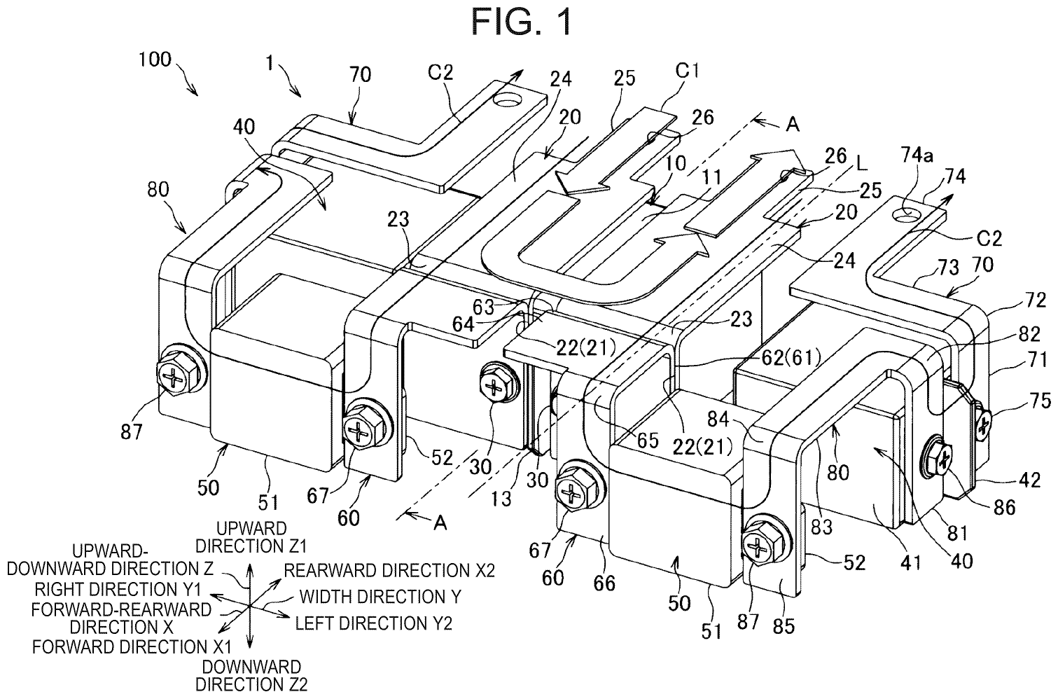

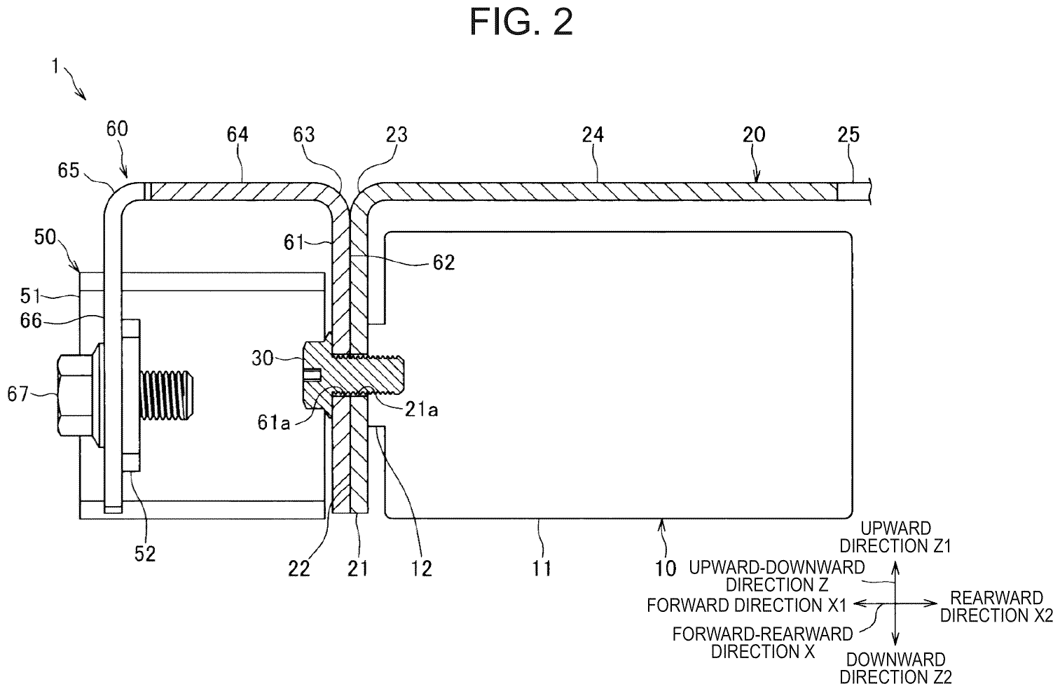

The first relay 10 and the first busbar 20 will be now described. The first relay 10 includes a first main body section 11 which is formed in a substantially rectangular-box shape with a material such as a resin. As shown in FIG. 2, a protrusion 12 is formed on an end face of the first main body section 11 oriented in the forward direction X1, wherein the protrusion 12 protrudes from the end face in the forward direction X1. As shown in FIG. 1, a separator wall 13 is formed in a central region of the face of the first main body section 11 oriented in the forward direction X1, wherein the separator wall 13 protrudes in the forward direction X1 and extends in the upward-downward direction Z. The protrusion 12 is formed on each of the right side Y1 and the left side Y2 of the separator wall 13. As shown in FIG. 2, the first busbar 20 is attached to an end face of the protrusion 12 oriented in the forward direction X1. The first busbar 20 is a conductor which is formed e.g. bending an electrically conductive metal sheet material, for example a copper or copper alloy, wherein the first busbar 20 is generally formed in a sheet shape. The first busbar 20 includes a first relay connected portion 21 (extending portion) which defines a forward X1 portion.

The first relay connected portion 21 is formed in a rectangular shape and extends in the upward-downward direction Z (predetermined direction) along the end face of the protrusion 12 of the first relay 10 oriented in the forward direction X1. A face of the first relay connected portion 21 oriented in the forward direction X1 defines a first side connected region 22 (connected region), wherein the first side connected region 22 is connected to the second busbar 60 to be in contact with the second busbar 60, as described below. A bolt hole 21a is formed in a central region of the first relay connected portion 21, wherein the bolt hole 21a extends through the first relay connected portion 21 in its direction of sheet thickness. Furthermore, an electrically conductive first flange bolt 30 (fastening element) is used to fix the first relay connected portion 21 to the protrusion 12 of the first relay 10 and to a first relay connected portion 61 of the second busbar 60 which will be described below. The first relay connected portion 21 is bent at its end oriented in the upward direction Z1 in the rearward direction X2 (direction of bending which is different from the predetermined direction) to define a bent portion 23. An upper plate section 24 is formed to be continuous with the bent portion 23. The upper plate section 24 is formed in a rectangular-plate shape and extends in the rearward direction X2 along a wall surface of the first relay 10 oriented in the upward direction Z1.

An end of the upper plate section 24 oriented in the rearward direction X2 defines an other-component connected portion 25, wherein the other-component connected portion 25 has a width dimension which is smaller than the remainder of the upper plate section 24. As shown in FIG. 1, a through hole 26 is formed in the other-component connected portion 25 in its portion oriented in the rearward direction X2, wherein the through hole 26 extends through the portion in a direction of sheet thickness of the other-component connected portion 25. A fastening element (not shown) is inserted through the through hole 26 to connect the other-component connected portion 25 to an object which is different from the first relay 10. In this manner, one end side of the first busbar 20, i.e., the first relay connected portion 21, is screwed to the first relay 10 while an opposite end side of the first busbar 20, i.e., the other-component connected portion 25, is connected to the object which is different from the first relay 10. In this configuration of the first relay 10 and the first busbar 20, a switch is arranged inside the first main body section 11 of the first relay 10. The switch is not shown and includes a fixed contact and a movable contact. Furthermore, for example a circuit on a fixed contact side inside the first main body section 11 is partially formed by the first flange bolt 30 on the right side Y1 and the first busbar 20 on the right side Y1 in FIG. 1.

In addition, a circuit on a movable contact side inside the first main body section 11 is partially formed by the first flange bolt 30 on the left side Y2 and the first busbar 20 on the left side Y2 in FIG. 1. The switch is configured to be switched on/off via controlling operation of the movable contact by a computer such as an ECU.

Next, the second relay 40, fuse 50, second busbar 60, third busbar 70 and fourth busbar 80 will be described. The second relay 40 includes a second main body section 41 which is formed in a substantially rectangular-box shape with a material such as a resin. As shown in FIG. 1, a second separator wall 42 is formed in a central region of an end face of the second main body section 41 oriented in the left direction Y2, wherein the second separator wall 42 protrudes in the left direction Y2 and extends in the upward-downward direction Z. Similarly to the first relay 10, a switch (not shown) is provided inside the second main body section 41 of the second relay 40, wherein the switch includes a movable contact, operation of which is controllable by a computer such as an ECU. The fuse 50 is configured to be e.g. molten and broken to prevent overcurrent when a current having a magnitude larger than or equal to a predetermined magnitude flows in a second circuit C2 within the electrical junction box 100 which will be described below. The fuse 50 includes a box-shaped fuse main body 51. The fuse main body 51 is arranged between the first relay 10 and each of the second relays 40. A flange-shaped connecting plate section 52 is formed on each of right and left end faces of the fuse main body 51, wherein the connecting plate section 52 protrudes outwardly in the width direction Y.

The second busbar 60 connects the first relay 10 to the fuse 50 and is connected indirectly to the second relay 40 via the fuse 50 and the fourth busbar 80 to form the second circuit C2 which will be described below. As shown in FIG. 2, the second busbar 60 includes the first relay connected portion 61 (extending portion), rearward bent portion 63, an upper wall section 64, a forward bent portion 65, and a fuse connected portion 66. The first relay connected portion 61 is formed in a rectangular shape and arranged on a side of the first relay connected portion 21 of the first busbar 20 which is oriented in the forward direction X1. The first relay connected portion 61 extends in the upward-downward direction Z (predetermined direction) along a face of the first relay connected portion 21 oriented in the forward direction X1. An end face of the first relay connected portion 61 oriented in the rearward direction X2 defines a second side connected region 62 (connected region), wherein the second side connected region 62 is connected to the first relay connected portion 21 of the first busbar 20 to be in contact therewith. A bolt hole 61a is formed in a central region of the first relay connected portion 61 and extends through the first relay connected portion 61 in the direction of sheet thickness, wherein the above-mentioned first flange bolt 30 is inserted through the bolt hole 61a.

The rearward bent portion 63 is bent in the forward direction X1 from an end of the first relay connected portion 61 which is oriented in the upward direction Z1. The upper wall section 64 is formed in a rectangular shape. The upper wall section 64 is continuous with the rearward bent portion 63 and extends in the forward direction X1. As shown in FIG. 1, the forward bent portion 65 is bent in the downward direction Z2 from a region which is located at an end of the upper wall section 64 oriented in the forward direction X1 and within a half of the upper wall section 64 on the left side Y2. The fuse connected portion 66 is formed in a rectangular shape. The fuse connected portion 66 is continuous with the forward bent portion 65 and extends in the downward direction Z2. A face of the fuse connected portion 66 oriented in the rearward direction X2 is in contact with a face of the connecting plate section 52 on the right side Y1 of the fuse 50, the face being oriented in the forward direction X1.

As shown in FIG. 2, the first relay connected portion 61 of the second busbar 60 which is configured as described above is coupled to the first relay connected portion 21 via screwing by inserting the first flange bolt 30 through the bolt hole 61a and bolt hole 21a. In this manner, the first busbar 20 is connected to the second busbar 60 by means of the electrically conductive first flange bolt 30 (fastening element). For the connection, the first relay connected portion 21 and the first relay connected portion 61 are overlapped with each other in the direction of sheet thickness so that a substantially entire surface of the first side connected region 22 of the first busbar 20 is in contact with a substantially entire surface of the second side connected region 62 of the second busbar 60, as shown in FIG. 2. For example in case of heat generation by one of the first relay connected portion 21 and the first relay connected portion 61, the contact between the first and second side connected regions 22 and 62 therefore facilitates heat diffusion into the other from the one of the first relay connected portions 21 and 61. This means that the first busbar 20 and the second busbar 60 are connected to be capable of releasing heat.

Furthermore, since the first relay connected portion 21 and the first relay connected portion 61 are overlapped with each other in the direction of sheet thickness, an increased sheet thickness of a busbar is obtained in this overlapped region so that heat may be less easily generated in this region than in a busbar having a smaller sheet thickness. It should be noted that although FIG. 2 shows that the first relay connected portion 21 and the first relay connected portion 61 with the heat releasing function are configured with a same sheet thickness, such a same sheet thickness may not be necessarily required, but any sheet thickness may be selected for each of the first relay connected portions 21 and 61.

For example, a larger or smaller sheet thickness may be selected for one of the first relay connected portion 21 and the first relay connected portion 61 than the other of the first relay connected portions 21 and 61. In this manner, the sheet thickness may be adjusted for the first relay connected portion 21 and the first relay connected portion 61 in the region with the heat releasing function so that the following advantages may be achieved over a single busbar which has an increased sheet thickness to obtain an improved heat releasing function: the adjustability may reduce constraints which may be put on an internal layout within the electrical junction box 100 in terms of shapes and/or arrangement of the busbars (first busbars 20/second busbars 60). This enables design flexibility to be increased for the first busbars 20 and the second busbars 60. In addition, a sheet thickness for one busbar may be reduced so that production costs for one busbar may be reduced.

On the other hand, the fuse connected portion 66 of the second busbar 60 is connected to the fuse 50 by means of a fifth flange bolt 67 which is inserted through the fuse connected portion 66 and the one of the connecting plate sections 52 on the right side Y1 of the fuse 50 in the direction of sheet thickness, as shown in FIG. 1.

Each of the third busbars 70 is configured to connect the corresponding second relay 40 to an object which is different from the second relay 40. Each of the third busbars 70 includes a second relay connected portion 71 (extending portion), a bent portion 72, a first planar plate section 73, and a second planar plate section 74. The second relay connected portion 71 is formed in a rectangular shape and extends in the upward direction Z1 (predetermined direction) from a region of the end face of the second main body section 41 oriented in the left direction Y2, the region being located rearwards X2 with respect to the second separator wall 42. The bent portion 72 is bent in the right direction Y1 (bending direction different from the predetermined direction) from an end of the second relay connected portion 71 oriented in the upper direction Z1.

The first planar plate section 73 is formed in a rectangular shape. The first planar plate section 73 is continuous with the bent portion 72 and extends in the right direction Y1 along a wall surface of the second main body section 41 oriented in the upward direction Z1. The second planar plate section 74 is formed in a rectangular shape and extends in the rearward direction X2 from an end of the first planar plate section 73 oriented in the right direction Y1. A through hole 74a is formed in the second planar plate section 74 in its portion oriented in the rearward direction X2, wherein the through hole 74a extends through the portion in a direction of sheet thickness of the second planar plate section 74. The second planar plate section 74 of each of the third busbars 70 which are configured in this manner is connected to the object which is different from the second relay 40, wherein the connection is provided by using a fastening element (not shown) which is inserted through the through hole 74a. On the other hand, the second relay connected portion 71 of each of the third busbars 70 is screwed to the corresponding second relay 40 by using a second flange bolt 75 which is inserted through the second relay connected portion 71 in the direction of sheet thickness and fastened to the second main body section 41.

The fourth busbars 80 are configured to the respective second relays 40 to the fuses 50. Each of the fourth busbars 80 includes a second relay connected portion 81 (extending portion), a first bent portion 82, a ceiling section 83, a second bent portion 84, and a fuse connected portion 85. The second relay connected portion 81 is formed in a rectangular shape and extends in the upward direction Z1 from a region of the end face of the second main body section 41 oriented in the left direction Y2, the region being located forwards X1 with respect to the second separator wall 42. The first bent portion 82 is bent in the right direction Y1 from the end of the second relay connected portion 81 oriented in the upward direction Z1. The ceiling section 83 is formed in a substantially L-shape which includes the following sections: a section which is continuous with the first bent portion 82 and extends in the right direction Y1, and a section extending in the forward direction X1.

The second bent portion 84 is bent into the downward direction Z2 from an end of the ceiling section 83 oriented in the forward direction X1. The fuse connected portion 85 is formed in a rectangular shape. The fuse connected portion 85 is continuous with the second bent portion 84 and extends in the downward direction Z2. A face of the fuse connected portion 85 oriented in the rearward direction X2 is in contact with a face of the connecting plate section 52 on the left side Y2 of the fuse 50, the face being oriented in the forward direction X1. The second relay connected portion 81 of each of the fourth busbars 80 which are configured as described above is coupled to the second relay 40 via screwing by inserting the third flange bolt 86 through the second relay connected portion 81 in its direction of sheet thickness and then fastening it to the second main body section 41. On the other hand, the fuse connected portion 85 of each of the fourth busbars 80 is coupled to the connecting plate sections 52 on the left side Y2 of the fuse 50 by means of a fourth flange bolt 87 which is inserted through the fuse connected portion 85 and the connecting plate sections 52 on the left side Y2 in the direction of sheet thickness.

In this configuration of the second relay 40, the fuse 50 and the second busbar 60, a switch is arranged inside the second main body section 41 of the second relay 40. The switch is not shown and includes a fixed contact and a movable contact. Furthermore, for example a circuit on a fixed contact side inside the second main body section 41 is partially formed by the second flange bolt 75 and the third busbar 70. In addition, a circuit on a movable contact side inside the second main body section 41 is partially formed e.g. by the third flange bolt 86 and/or the third busbar 70. The switch is configured to be switched on/off by controlling operation of the movable contact by a computer such as an ECU.

Next, operation of the electrical junction box 100 including the connecting structure 1 will be explained. In a state shown in FIG. 1, the switch of the first relay 10 is first switched on while the switch of the second relays 40 are switched off. As a result, a powered state of the first circuit C1 (predetermined electrical circuit) is established in which it is supplied with power so that a current flows as follows: In the powered state of the first circuit C1, the current flows through the other-component connected portion 25, the upper plate section 24, the bent portion 23, and the first relay connected portion 21 of the first busbar 20 on the right side Y1, and the first flange bolt 30 and the fixed contact (not shown) inside the first main body section 11 on the right side Y1 in this order. After reaching the fixed contact which is not shown, the current further flows through the movable contact (not shown), the first flange bolt 30 on the left side Y2, and the first relay connected portion 21, the bent portion 23, the upper plate section 24, and the other-component connected portion 25 of the first busbar 20 on the left side Y2 in this order.

On the other hand, the off-state of the switch of each of the second relays 40 results in a non-powered state of a corresponding one of the second circuits C2 in which the second circuit C2 including the first busbar 20, the first flange bolt 30, the second busbar 60, the fuse 50, the fourth busbar 80, the second relay 40, and the third busbar 70 is supplied with no power. When a relative high current flows through the first circuit C1 during this non-powered state of the second circuits C2, heat is generated by the first relay 10 and the first busbars 20 forming part of the first circuit C1. However, since the second circuits C2 are supplied with no power in the powered state of the first circuit C1 as described above, the second busbars 60 are supplied with no power so that they do not generate heat, unlike the first busbar 20. In addition, the first relay connected portions 21 of the first busbars 20 are coupled to the respective first relay connected portions 61 of such second busbars 60 via screwing by means of the first flange bolts 30. Therefore, the heat generated in the first busbars 20 are diffused into the second busbars 60 via the respective first relay connected portions 21 and first flange bolts 30. This means that the second busbars 60 function as heat releasing regions for the first relay 10 and the first busbars 20. On the other hand, when the switch of the first relay 10 is switched off and the switches of the second relays 40 are switched on, the first circuit C1 is switched into a non-powered state in which it is supplied with no power while the second circuits C2 are switched into a powered state in which they are supplied with power.

As described above, the connecting structure 1 includes the first circuit C1 which is formed by the first relay 10 and the first busbars 20 and switched between the powered state and the non-powered state by the first relay 10. The connecting structure 1 further includes one or more second circuit C2, each of which is formed by the second relay 40, the fuse 50, the first busbar 20, the second busbar 60, the third busbar 70 and the fourth busbar 80 and switched between the powered state and the non-powered state by the second relay 40. This means that the connecting structure 1 includes at least two electrical circuits. Furthermore, the second busbars 60 connected to the first busbars 20 to be capable of releasing heat are in the non-powered state in the powered state of the first circuit C1.

For example in case of a high current flowing through the first circuit C1 which results in heat generation in the first relay 10 and the first busbars 20, the second busbars 60 according to the above-described embodiment are thus switched into the non-powered state to make it difficult to generate heat in the second busbars 60. Furthermore, since the second busbars 60 are connected to the first busbars 20 to be capable of releasing heat, the second busbars 60 function as heat releasing regions for the first busbars 20. In this manner, a connecting structure 1 may be obtained which enables heat generated in the first busbars 20 (busbar) and the first relays 10 (relay) to be efficiently diffused which form the first circuit C1 (electrical circuit).

According to the present embodiment, it is further possible to easily connect each of the first busbars 20 to a corresponding one of the second busbars 60 by means of the first flange bolt 30 (fastening element).

According to the present embodiment, it is further possible to efficiently release the heat via the connected regions (first side connected region 22 and second side connected region 62) of the first busbars 20 and the respective second busbars 60 which are overlapped with each other. In addition, since any sheet thickness may be selected for each of the connected regions, the sheet thickness of the connected regions of the first busbar 20 and the second busbar 60 may be varied in a variety of manners. When installing the connecting structure 1 in the electrical junction box 100, the first busbars 20 and the second busbars 60 are therefore less likely to be affected in terms of their shape and/or size e.g. by constraints on a layout of the busbars 20, 60. Furthermore, the functionality of the above-described heat releasing regions tends to be more improved with increase in the sheet thickness of the busbars. Therefore, this sheet thickness may be a total thickness of the connected regions of the first busbar 20 and the second busbar 60. Therefore, a sheet thickness for one busbar may be reduced as compared to a heat releasing region formed by a single busbar with an increased sheet thickness. As a result, workability for one busbar may be improved.

Moreover, the design flexibility for the first busbars 20 and the second busbars 60 according to the present embodiment may be easily improved by combination of the extending portions such as the first relay connected portion 21 with the bent portions such as the bent portion 23.

According to the present embodiment, it is further possible to obtain an electrical junction box 100 that may enable heat generated in the first busbars 20 and the first relay 10 to be efficiently diffused which form the first circuit C1.

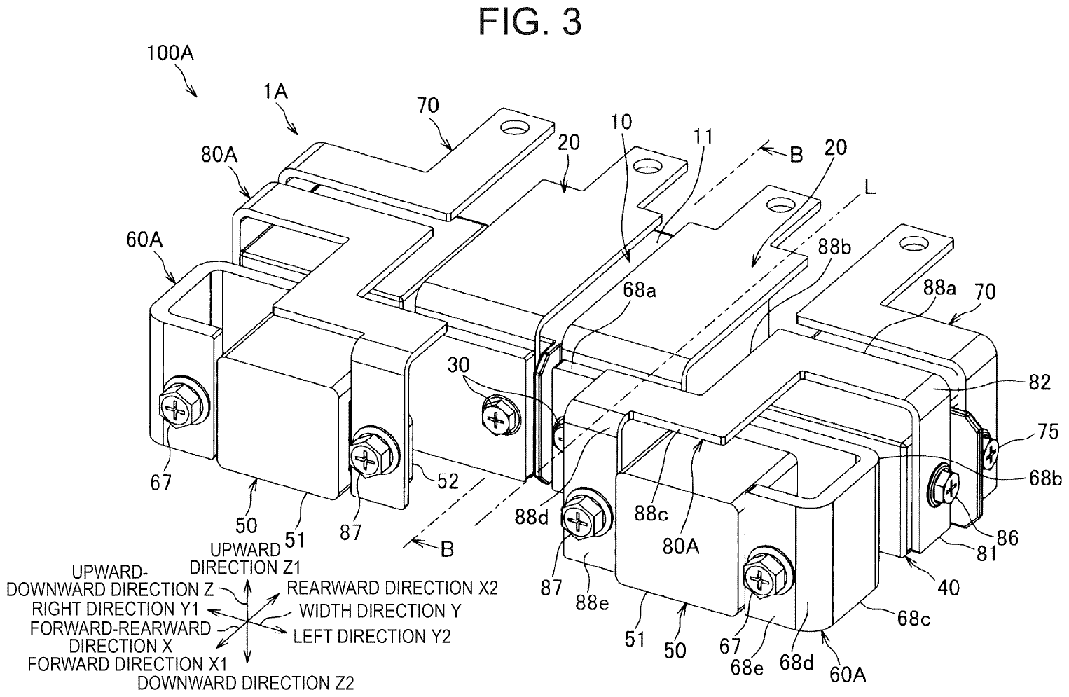

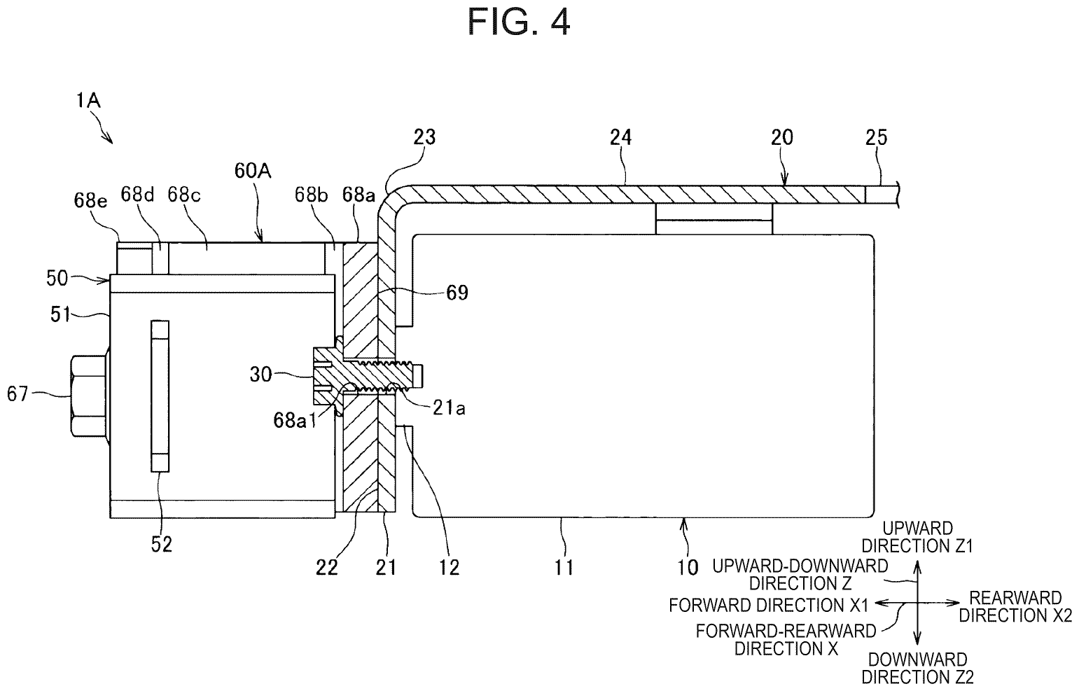

Next, an exemplar variant will be described. FIG. 3 shows a partial perspective view of an electrical junction box 100A including a connection structure 1A according to an exemplar variant. FIG. 4 shows a partial sectional view of the electrical junction box along the line B-B as viewed in the direction of arrow in FIG. 3. According to the exemplar variant, the connecting structure 1A of the electrical junction box 100A includes fourth busbars 80A and second busbars 60A. The fourth busbars 80A correspond to the aforementioned fourth busbars 80, and the second busbars 60A correspond to the second busbars 60. The second busbars 60A are formed with a larger sheet thickness as compared to the first busbars 20. Each of the second busbars 60A includes a first relay connected portion 68a, rearward bent portion 68b, a lateral wall section 68c, a forward bent portion 68d, and a fuse connected portion 68e.

The first relay connected portion 68a is formed in a rectangular shape and arranged on a side of the first relay connected portion 21 of the first busbar 20 which is oriented in the forward direction X1. The first relay connected portion 68a extends in the width direction Y along the face of the first relay connected portion 21 oriented in the forward direction X1, and also protrudes from the first relay connected portion 21 to extend in the left direction Y2.

As shown in FIG. 4, an end face of the first relay connected portion 68a oriented in the rearward direction X2 defines a second side connected region 69 (connected region), wherein the second side connected region 69 is connected to the first relay connected portion 21 of the first busbar 20 to be in contact therewith. A bolt hole 68a1 is formed in a central region of the first relay connected portion 68a and extends through the first relay connected portion 68a in the direction of sheet thickness, wherein the above-mentioned first flange bolt 30 extends through the bolt hole 68a1. The first relay connected portion 68a is thereby screwed to the first relay connected portion 21. As shown in FIG. 3, the rearward bent portion 68b is bent in the forward direction X1 from an end of the first relay connected portion 68a oriented in the left direction Y2. The lateral wall section 68c is formed in a rectangular-plate shape. The lateral wall section 68c is continuous with the rearward bent portion 68b and extends in the forward direction X1.

The forward bent portion 68d is bent in the right direction Y1 from an end of the lateral wall section 68c oriented in the forward direction X1. The fuse connected portion 68e is formed in a rectangular-plate shape. The fuse connected portion 68e is continuous with the forward bent portion 68d and extends in the right direction Y1. A face of the fuse connected portion 68e oriented in the rearward direction X2 is in contact with a face of the connecting plate section 52 on the left side Y2 of the fuse 50, the face being oriented in the forward direction X1. In addition, the fuse connected portion 68e is coupled to one of the connecting plate sections 52 on the left side Y2 of the fuse 50 by means of a fifth flange bolt 67 which is inserted through the fuse connected portion 68e and the one of the connecting plate sections 52 on the left side Y2 in the direction of sheet thickness.

Each of the fourth busbars 80A includes a second relay connected portion 81, a first bent portion 82, a first ceiling section 88a, a second ceiling section 88b, a third ceiling section 88c, a second bent portion 88d, and a fuse connected portion 88e. Since the second relay connected portion 81 and the first bent portion 82 are configured in a same manner as those in the aforementioned embodiment, detailed description thereof is omitted. The first ceiling section 88a is formed in a rectangular-plate shape. The first ceiling section 88a is continuous with the first bent portion 82 and extends in the right direction Y1. The second ceiling section 88b is formed in a rectangular-plate shape. The second ceiling section 88b is continuous with an end of the first ceiling section 88a and extends in the forward direction X1, the end of the first ceiling section 88a being oriented in the right direction Y1. The third ceiling section 88c is formed in a rectangular-plate shape. The third ceiling section 88c is continuous with an end of the second ceiling section 88b and extends in the right direction Y1, the end of the second ceiling section 88b being oriented in the forward direction X1.

The second bent portion 88d is continuous with an end of the third ceiling section 88c oriented in the forward direction X1 and is bent into the downward direction Z2. The fuse connected portion 88e is formed in a rectangular-plate shape. The fuse connected portion 88e is continuous with the second bent portion 88d and extends in the downward direction Z2. A face of the fuse connected portion 88e oriented in the rearward direction X2 is in contact with a face of the connecting plate section 52 on the right side Y1 of the fuse 50, the face being oriented in the forward direction. The second relay connected portion 81 of each of the fourth busbars 80A which are configured as described above is coupled to the second relay 40 via screwing by inserting the third flange bolt 86 through the second relay connected portion 81 in its direction of sheet thickness and then fastening it to the second main body section 41. On the other hand, the fuse connected portion 88e of each of the fourth busbars 80A is coupled to the connecting plate sections 52 on the right side Y1 of the fuse 50 by means of a fourth flange bolt 87 which is inserted through the fuse connected portion 88e and the connecting plate sections 52 on the right side Y1 in the direction of sheet thickness.

The above-described exemplar variant enables a same effect/advantage to be achieved as the previous embodiment. The exemplar variant also enables the present invention to be applied to one or more embodiments with the first relay connected portions 68a of the second busbars 60A extending in the width direction Y. This means that the present invention may be applied to connecting structures with busbars having various shapes.

It should be noted that the above-described embodiment and exemplar variant are provided merely for illustrating some of implementations of the connecting structure 1 and the electrical junction box 100 and the present invention is not limited thereto. For example, the first relay 10, the second relays 40, and the fuses 50 mentioned in the above embodiment are provided as mere examples of an electronic component, and any other electronic components may be selected and/or added as appropriate. Additionally, the fuses 50 may be omitted. Furthermore, in addition to the first circuit C1 and the second circuits C2, other electrical circuits may be provided within the electrical junction box 100. Moreover, a fastening element may be provided which is different from the first flange bolt 30. For example, the fastening element may be configured with an electrically conductive bolt and a washer. In addition, an element which is different from a fastening element may be used to provide connection between the busbars and relays or between the busbars. Alternatively, instead of such an element, e.g. soldering may be used to provide connection between the busbars and relays or between the busbars.

### Reference Signs List

C1 First circuit
C2 Second circuits
1 Connection structure
10 First relay
20 First busbars
40 Second relays
60 Second busbars

What is claimed is:

1. A connection structure of relays and busbars forming a plurality of electrical circuits,
wherein the relays include:
a first relay configured to switch a first circuit as a predetermined electrical circuit between a powered state and a non-powered state; the first circuit being configured to be supplied with power in the powered state and to be supplied with no power in the non-powered state; and
a second relay configured to switch a second circuit as a predetermined electrical circuit between a powered state and a non-powered state, the second circuit being configured to be supplied with power in the powered state and to be supplied with no power in the non-powered state,
wherein the second circuit is different from the first circuit,
wherein the busbars include:
a first busbar connected to the first relay to form the first circuit; and
a second busbar connected to the second relay to form the second circuit,
wherein the first busbar and the second busbar are connected to be capable of releasing heat, and
wherein the second busbar is configured to be in the non-powered state in the powered state of the first circuit.

2. The connection structure according to claim 1,
wherein the first busbar and the second busbar are connected to each other via an electrically conductive fastening element.

3. The connection structure according to claim 2,
wherein the first busbar and the second busbar are connected to each other in connected regions of the first busbar and the second busbar,
wherein each of the connected regions of the first busbar and the second busbar is formed with an arbitrarily selected sheet thickness, and
wherein the first busbar and the second busbar are connected while being in contact with each other in a direction of sheet thickness.

4. The connection structure according to claim 1,
wherein each of the first busbar and the second busbar includes:
an extending portion extending along a predetermined direction; and
a bent portion which is bent into a direction of bending;
wherein the direction of bending is different from the predetermined direction.

5. An electrical junction box comprising:
the connection structure according to claim 1; and
a case accommodating the connection structure.
